(19) United States
(12) Patent Application Publication
(10) Pub. No.: US 2009/0006246 A1
(43) Pub. Date: Jan. 1, 2009

(54) Method and System for Simulating an On-Line Credit Application

(76) Inventors: Patrick Fallon, Atlanta, GA (US); John Hogan, Alpharetta, GA (US); Donald Murphy, Cumming, GA (US); John Wunderlich, Roswell, GA (US)

Correspondence Address: PHILIP H. BURRUS, IV, 460 Grant Street, Atlanta, GA, 30312, US

(21) Appl. No.: 12/208,994

(22) Filed: Sep. 11, 2008

Related U.S. Application Data
(62) Division of application No. 11/614,255, filed on Dec. 21, 2006.

(51) Int. Cl. G06Q 40/00

(52) U.S. Cl. 705/38

(57) ABSTRACT

A system and method for testing an electronic or on-line credit application process is provided. The system and method, which may be run in a production environment, include selecting at least one fictional credit applicant entity from an entity database. A script database then executes one or more predetermined test scripts using the information from the entity database to simulate a real credit application through the electronic or on-line process. Screen shots or other data may then be recorded such that a tester may review the process to ensure the system is properly operational.

### BACKGROUND

1. Technical Field

This invention relates generally the field of automated diagnostic testing systems, and more specifically to a method and system for testing online credit offering systems by simulating applications.

2. Background Art

In recent years, banks and other financial institutions and service providers have had to change the way they offer their credit and loan services due to the popularity of the Internet. In the past, the only way for a person to apply for a line of credit was to be physically present with the loan provider. The process the applicant would then undertake was lengthy due to the fact that the process was completed primarily on paper. The financial institution would need access to the applicant's personal and financial history in order to determine if the applicant was worthy of a loan, an extension of credit, or some combination thereof. In obtaining this information, the financial institution would need to telephone, mail, or transmit by facsimile to other institutions requesting the applicant's information. After waiting for all the applicant's personal and financial history to be collected, the financial entity would then have to analyze this data and provide a credit response to the applicant. This entire process may have taken days or even weeks to complete.

The introduction of the Internet and the automated high-speed communication of data, this process of applying for a line of credit has shorted immensely. People now have the option of accessing a financial entity's website and applying for a line of credit on line. The technology used to create an automated system and method for offering a line of credit to people with access to a web portal is already being used by many major bank, financial institutions and lending services. By way of example, one such system is taught by Smorodinsky in U.S. Pat. No. 5,884,290, entitled “Method of transferring funds employing a three-node real-time electronic interlock.” This method teaches a system where an applicant sends a request to a financial institution for a line of credit and the financial institutions runs a series of tests to determine if the applicant should receive the credit line.

Technology such as the one described above and others like it are commonly being used everyday by potential credit applicants. The reliability and integrity of these systems is very important, as they affect the distribution of money. It would potentially be a large burden to a financial institution if their web based automated credit offering system were to malfunction so as to begin to approve lines of credit to those whom otherwise would have been denied. Further, as consumers have a choice in the market regarding from whom to borrow money, a malfunctioning website could potentially frustrate customers, thereby leading them to turn to other financial entities or service providers.

There is therefore a need for a means to test and confirm correct functionality of a financial entity's web based automated credit-offering system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a system for testing an on-line credit application process in accordance with embodiments of the present invention.

FIG. 2 illustrates components of a system for testing an on-line credit application process in accordance with embodiments of the present invention.

FIG. 3 illustrates a method for testing an on-line credit application process in accordance with embodiments of the invention.

FIG. 4 illustrates method steps for testing an on-line credit application process in accordance with embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to method and system for testing an electronic or on-line credit process. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain networks and non-processor circuits, some, most, or all of the functions of method and system for testing an electronic credit process as described herein. The non-processor circuits may include, but are not limited to, wireless transceivers, network communication modules, signal drivers, clock circuits, power source circuits, databases, and user input and computing devices. As such, these functions may be interpreted as steps of a method to perform method and system for testing an electronic credit application process or system. Alternatively, some or all functions could be implemented by a state machine that has no stored program instructions, or in one or more application specific integrated circuits, in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the present invention are used in testing electronic or on-line credit application and approval/rejection systems offered by financial entities, which may include lenders, financial institutions, financial service providers, or other businesses engaged in monetary commerce. Embodiments of the present invention are suitable to credit card providers, mortgage lenders, short-term credit providers, and the like to test the various systems and processes associated with on-line applications in a production environment.

By way of example, many financial entities offer a portfolio of products to customers, including short-term loans, secured loans, credit cards, debit cards, lay-away plans, and other similar credit based offerings. With the advent of the Internet and networked computing, many financial entities have streamlined the traditional paper-based application process into an electronic process that may be accessed with a personal computer via a client interface. One example of such a client interface is a web browser that is configured to communicate with remote servers across a wide area network, such as the Internet or World Wide Web.

Multiple credit products lead financial entities to provide multiple application websites with which consumers may apply for each offering. For instance, there may be a first website for one credit card, a second website for a second credit card, another website for mortgages, another website for secured credit cards, another website for payday loans, and so forth. In addition to the credit application websites, each lender typically develops a corresponding customer service website, a loan invitation or solicitation website, a special site for pre-qualified borrowers, and various foreign language websites.

One problem financial entities and their corresponding programming and information technology departments face in managing each of these websites, as well as new websites that appear, is ensuring that each website portal and its corresponding sites and pages are operating properly. Embodiments of the present invention test these various electronic credit offering systems and affiliated electronic systems to ensure proper execution and operation.

While testing can be achieved manually in an off-line, test environment, embodiments of the present invention provide both testing and visibility in an on-line, production environment. Embodiments of the present invention execute predefined test scripts using fictional entities having fictional credit histories associated therewith to exercise the electronic credit offering in the production environment. A recording module then records the results of the testing. After a predetermined time, test data produced during the testing process may then be filtered out within a decisioning process prior to fulfillment, such as an actual transfer of funds, taking place.

Further, embodiments of the invention are capable of testing the customer experience. This is true because actual customer interface data is captured and stored. Business analysts or customer satisfaction specialists may review the data to determine the exact look and feel that a customer would experience while interfacing with the financial entity. Quality control specialists may review the data to ensure that changes made to the customer portal, including website appearance changes, data collection changes, banner advertising, pop-up portals, and the like have been properly implemented. In one embodiment, where the customer interface is for obtaining a loan, the entire credit decision process may be monitored and recorded as well.

In one embodiment, the fictional entities and their corresponding credit histories are tagged with a special message called the “type S” flag. Responses from the electronic credit application process and associated web pages or portals are then correspondingly tagged with the type S flag. By analyzing type S data, real production environment web pages and application processes may be examined for operational performance and to verify processes. The type S account information may then be purged from the system prior to a transfer of funds.

Embodiments of the invention provide financial entities with the ability to validate credit offering process functionality by using fictional entities and corresponding credit histories in a production environment for post-production verification and on-going verification needs. Embodiments also provide the ability to validate electronic credit offering functionality while confirming that no negative impact occurs in relation to existing web sites as new sites as enhancements are implemented.

Another aspect of the invention occurs due to the real-time, production testing that is capable with embodiments of the invention. In one embodiment, the invention records real, production data and stores this data to a system of records. As financial entities operate in a highly regulated environment, review of this data is useful for ensuring governmental compliance. By way of example, where a first loan type is legal in some states, yet not in others, regulatory agencies may review the test data to ensure that the citizens of their state receive a customer portal experience that is in accordance with it's laws.

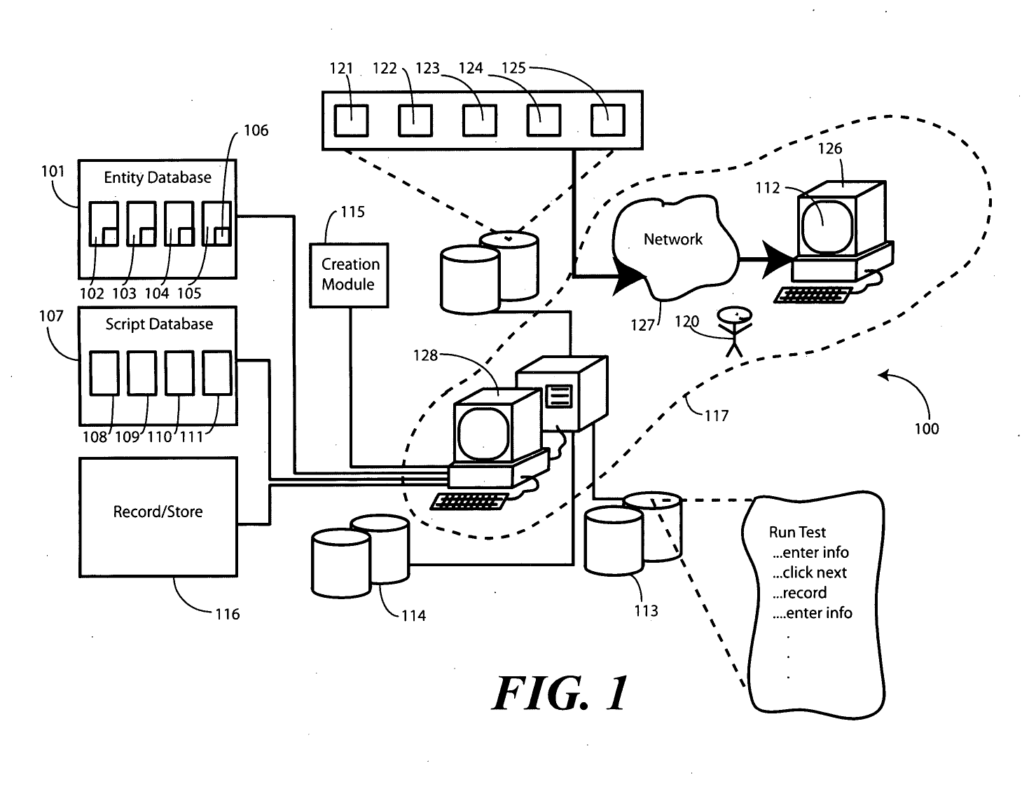

Turning now to FIG. 1, illustrated therein is a system 100 for testing an electronic or on-line credit application process in accordance with one embodiment of the invention. The system 100 is suitable for testing a credit application process where the application consists of a series of websites into which prospective borrower information is entered. The system 100 also is suitable for validating and verifying back end operations such as retrieval of a credit report or financial institution data. As used herein, “production environment” refers to a system that is operational to the extent that it can be accessed by a potential borrower and the financial entity for the purpose of executing a commercial transaction such as the receipt of an application for credit.

The on-line credit application, in one embodiment, consists of a plurality of predefined client interface modules 121,122,123,124,125. These client interface modules 121,122,123,124,125 may be a series of web sites, delivered from a central computer 128 to a customer 120 through a network.

An entity database 101, which may be under the control of the financial entity, or in the case of an outsourcing scenario may be under the control of a third party service provider, includes one or more fictional credit applicant entities 102,103,104,105. The fictional credit applicant entities 102,103,104,105 may include businesses or individuals, and serve as model applicants for credit with model information. For instance, in the case of an individual, the fictional credit applicant entities 102,103,104,105 may include a name, address, age, telephone number, social security number, employment information and the like.

Each fictional credit applicant entity 102,103,104,105 includes an associated financial history 106. The associated financial history 106 may vary from fictional credit applicant entity to fictional credit applicant entity. By way of example, one financial history may be that of an individual who has recently undergone bankruptcy proceedings. Another may be for a long time homeowner with excellent credit. Another may be for a student with a fairly limited credit history. Another may be for a borrower who has had a rejection in the past six months for an application of credit, has a history of paying obligations late, and who has large outstanding balances on existing lines of credit. These financial history types are exemplary only, as it will be clear to one of ordinary skill in the art having the benefit of this disclosure that there are a myriad of possible combinations and permutations of credit and financial history indicia of relevance to financial entities.

A script database 107 operates in conjunction with the entity database 101 to test the various systems and procedures by way of the plurality of client interface modules 121,122,123,124,125. The script database includes one or more predefined test scripts 108,109,110,111. Each test script includes a program for selecting one or more of the fictional credit applicant entities 102,103,104,105, accessing each of the plurality of client interface modules 121,122,123,124,125, entering the proper information from each fictional credit applicant entity into each client interface module, verifying performance and optionally recording the resulting action.

The script database 107 and entity database 101 operate, in one embodiment, by way of a test module 113. The test module 113 is configured to execute one or more of the predefined test scripts 108,109,110,111 by employing at least one of the one or more fictional credit applicant entities 102,103,104,105. The test module 113 does this by accessing a networked client interface 112, which may be in a production environment 117, and supplying information from the entity database in accordance with a test script from the script database 107. In one embodiment, the test module 113 is configured such that a user may manually step through the script process so as to troubleshoot in real time.

It is well to note that the test module 113 is capable of executing test scripts at various points along the process. In other words, the test scripts need not always run from the first client interface module to the last. Certain testing routines will be better served where the test scripts are configured to test only certain subsets of the client interface modules. Thus, in one embodiment, the test module 113 is configured to execute one or more predefined test scripts 108,109,110,111 beginning at any of the plurality of client interface modules 121,122,123,124,125. Correspondingly, the test module 113 may be configured to terminate execution of the one or more predefined test scripts 108,109,110,111 at any of the plurality of client interface modules 121,122,123,124,125.

Other test scripts may be used to determine other operational data from the overall system 100. For example, in one embodiment, the test module 113 may execute a test script to determine whether the networked client interface 112 is operational by ensuring that each client interface module 121,122,123,124,125 is operational. Similarly, the test module 113 may execute a test script to ping certain client interface modules in the production environment 117, or to obtain traffic data through the network 127 in the production environment, to determine how many customers are accessing the networked client interface 112 at a predetermined moment in time.

A recording device 114, in communication with the test module 113, is then configured to record the execution of the one or more test scripts 108,109,110,111. Where, for instance, the plurality of client interface modules 121,122,123,124,125 comprise a series of web pages that operate with a central computer 128 or server, the recording device 114 may simply capture screen shots of each client interface module. Alternatively, the recording device 114 may capture a screen shot of the resulting client interface module, where for example information is entered at a first client interface module and is stored or otherwise operated upon by accessing another, subsequent client interface module.

The recording device 114, in one embodiment, is in communication with a system of records 116. The system of records 116, which may be a server or other data storage means, is configured to store information recorded during the execution the execution of the one or more test scripts 108,109,110,111.

So that the system 100 may be customized to each financial entity's specific needs, in one embodiment the system includes a fictional entity creation interface 115, which is in communication with the entity database 101. A financial entity may use the fictional entity creation interface 115 to create, modify, or delete fictional credit applicant entities in the entity database 101. The financial entity may also customize, alter, amend, create, or remove credit history information associated with each of the fictional credit applicant entities by way of the fictional entity creation interface 115. In one embodiment, the fictional entity creation interface 115 may be a web portal structured as a form that stores entity information in a database within the entity database 101.

By way of example, where the financial entity is a lender, and the lender wishes to test the decision process of its website, the lender may create multiple credit applicant entities to ensure that those eligible for a loan receive and offer, and correspondingly, that those ineligible for a loan do not. Where, for instance, one of the decision mechanisms is a credit score, the lender may create one fictional credit applicant entity having a Fair Isaac & Co. (FICO) score of less than 620, while another has a FICO score above 620. Where 620 is a decision threshold, the entity with a score less than 620 should receive a rejection, while the entity with a score above 620 receives an offer.

Other characteristics could similarly be configured by way of the entity creation interface 115. Fictional credit applicant entities may have states of residence that forbid certain offers. Where such an entity attempts to receive an offer not permitted by the law of the designated state, the financial entity may confirm that such applicants are barred from applying for such offers. Similarly, if a fictional credit applicant entity has financial information indicating that it has applied and been rejected for an offer within the previous 90 days, the financial institution may confirm that such an entity is not allowed to receive an offer.

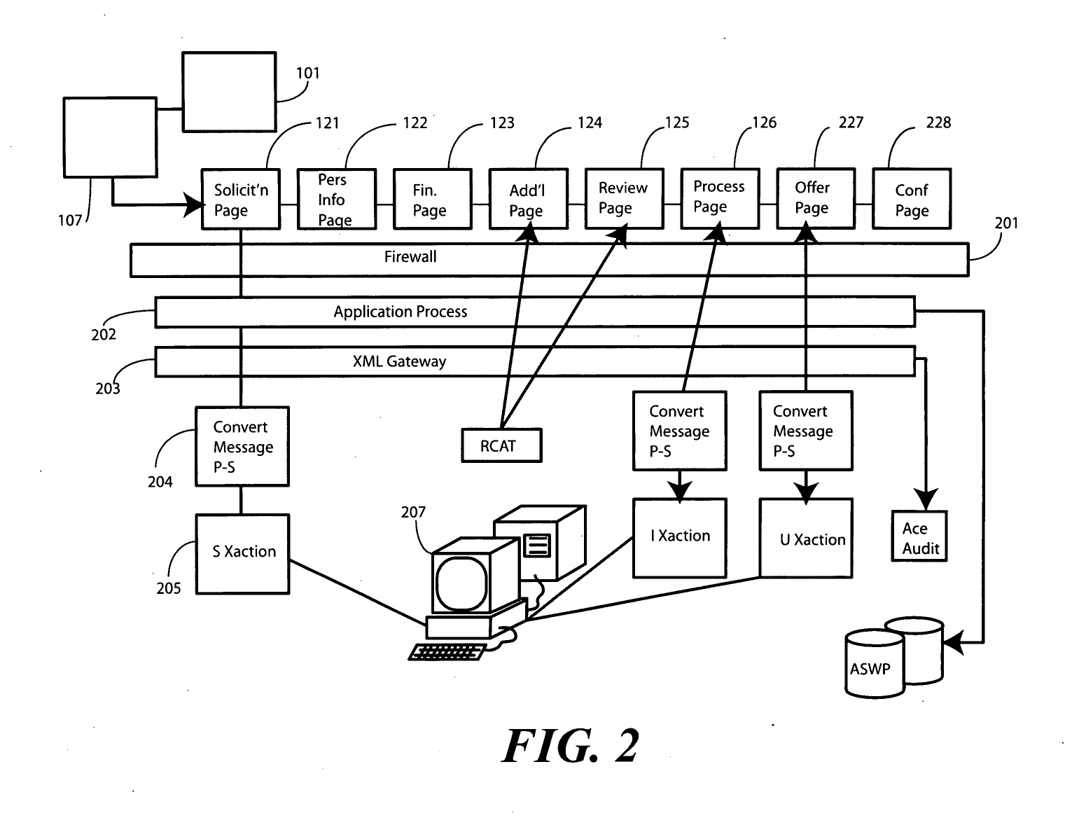

Turning now to FIG. 2, illustrated therein is a production diagram for certain components of a system (100) in accordance with embodiments of the invention. The production diagram is similar to that which might be used by a development team when developing a test system in accordance with the invention.

The plurality of client interface modules 121,122,123,124,125, 226,227,228 are shown as exemplary modules that might be used for a credit offering system. The modules are exemplary in nature only, as it will be clear to those of ordinary skill in the art having the benefit of this disclosure that differing products or applications may dictate other types of modules.

The exemplary modules include the following: module 121 is an optional solicitation module. Such a module may be used where a potential borrower receives a pre-approved offer by mail and is directed to a special pre-approved website. Module 122 is a personal information module where a potential borrower enters personal information, such as name, address, social security number, and the like.

Module 123 is a financial information module where a potential borrower may enter information such as bank account numbers, outstanding loans, and similar information. Module 124 is an optional module where additional information may be entered. Examples of additional information include number of years at a residence and employment information.

Module 125 is a review module where information entered by a prospective borrower may be reviewed for accuracy. Further, corrections to erroneous information may be allowed through module 125. Upon reaching module 125, the entered information is being processed, and the potential borrower is notified of this fact. Processing may include verification of the entered information, retrieval of bank records or credit reports, and other similar analysis. Module 227 is an offer module where an offer of credit may be presented. Additionally, regulatory information, including state and federal lending regulations, may be presented at module 227. Module 228 is a confirmation module that the process has been completed.

These plurality of client interface modules 121,122,123,124,125,226,227,228 are presented from a central computer 207, which may be protected by a firewall 201. An application layer 202 and an XML gateway 203 help to facilitate the generation and processing of the plurality of client interface modules 121,122,123,124,125,226,227,228.

The script database 107, operating in conjunction with the entity database 101, is configured to enter information selected from the fictional credit applicant entities. Where the S flag is employed to identify the entity and the resulting files as test files, the production flag is converted to the S flag at module 204. The information is verified at module 205.

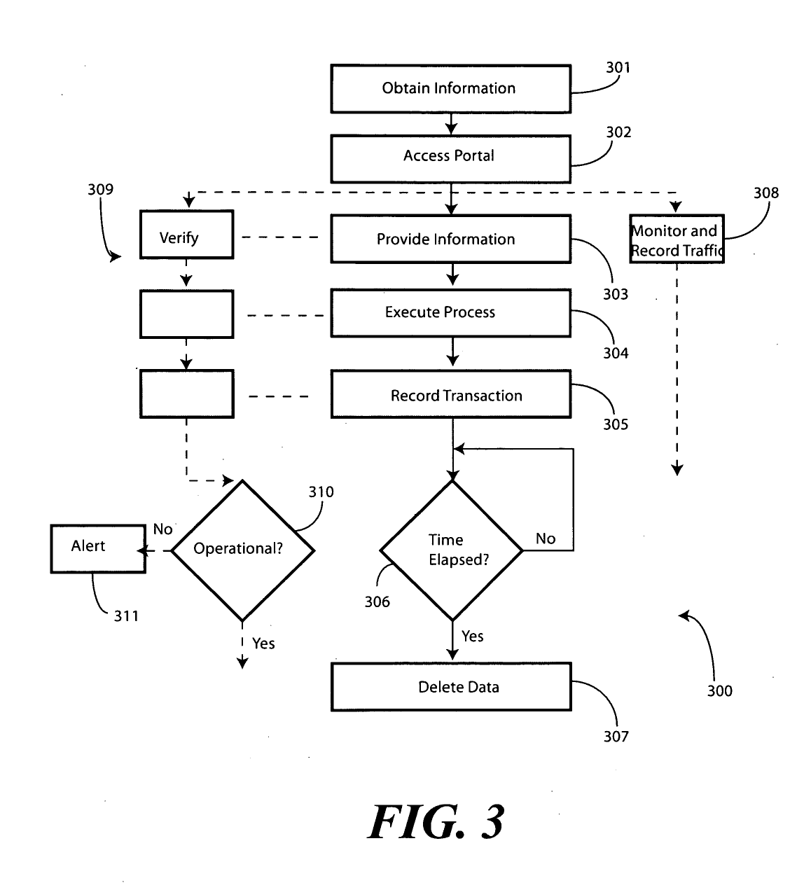

Turning now to FIG. 3, illustrated therein is a method 300 for testing an electronic or on-line credit application system in accordance with embodiments of the invention. The method is suitable for programming as software to be operational with a system such as that shown in FIG. 1.

At step 301, information relating to at least one fictional credit applicant entity, including a credit history corresponding to the fictional credit applicant entity, is retrieved from an entity database (101). At step 302, a networked credit offer portal, such as a credit offer web page, is accessed.

At step 303, information associated with the fictional credit applicant entity and the credit history associated therewith is entered into the appropriate client interface modules of the networked credit offer portal. At step 304, at least a portion of the credit application process is executed. This execution could be as simple as actuating a “next” or “continue” button on one of the client interface modules. It may also include execution of back operations such as verifying bank or credit information.

At step 305, the transaction step of the portion of the credit application process are recorded. The step of recording may further include storing images, such as screen captures, of the various client interface modules presented by the networked credit offer portal, in a system of records. This step may also include the generation of a process flow diagram so that a tester may be quickly alerted as to which path through the various client interface modules the particular fictional credit applicant entity was directed. The step of recording allows a tester to later review the steps that occurred during the test procedure. The resulting files and data that are created during the testing process may then be retained for a predetermined amount of time. This retention of data allows testers to further review test data should anomalies be detected during review of the recordings. Upon a predetermined period of time elapsing, as determined at decision 306, some or all of the data created during the step of testing may be deleted at step 307.

The method 300 may also include other optional steps. For instance, customer access data supplied by actual customers, or supplied from fictional credit applicant entities, may be monitored and recorded as a part of the recording step 305. Further, at steps 309, and throughout the method 300, reliable and functional operation of the networked credit offer portal may be verified. Where the credit offer portal comprises a series of electronic interfaces or web pages, for example, the steps 309 of verifying the operation of the portal may include verifying that the networked credit offer portal is capable of presenting each of the web pages. Where the networked credit offer portal malfunctions, as detected at decision 310, an alert identifying which of the plurality of client interface modules can not be presented is actuated at step 311.

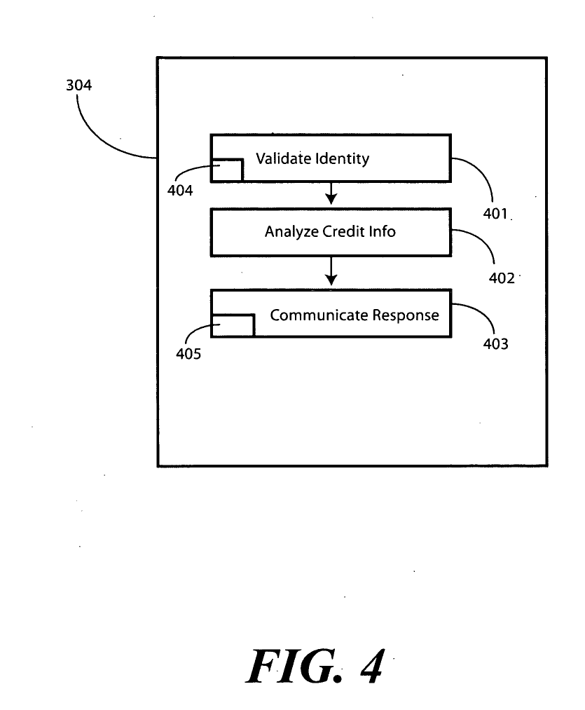

Turning now to FIG. 4, illustrated therein are some of the sub-steps that may be included in the step 304 of executing at least a portion of the credit application process. As information relating to the fictional credit applicant entity is generally entered during the testing process, this information may be verified during the testing process. For instance, at step 401, the identity of the fictional credit applicant entity may be verified. As a part of this step, as indicated by block 402, the step of verifying the identity of the fictional credit applicant entity may include verifying the social security number associated with the fictional credit applicant entity, or matching the social security number with the last name of the fictional credit applicant entity.

At step 403, the credit history associated with the fictional credit applicant entity may be analyzed. This analysis may include determining a credit rating or credit score for the fictional credit applicant entity. Similarly, this analysis may include accessing or confirming credit report data and financial institution data, such as banking records.

At step 404, a credit response, such as an approval or denial of credit, may be communicated to the fictional credit applicant entity by way of one of the client interface modules. For instance, where a customer may be directed to a web page that indicates credit approval or denial, such a web page may be generated as a part of the testing process and then captured as a part of the recording process. Further, this step may include the alternate step of providing an advertisement for an additional financial product as indicated at step 405. Examples of additional financial products include credit balance transfers where credit is approved, or alternative credit instruments where credit is denied.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. For example

Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. (canceled)

2. (canceled)

3. (canceled)

4. (canceled)

5. (canceled)

6. (canceled)

7. (canceled)

8. (canceled)

9. (canceled)

10. (canceled)

11. A method for testing an electronic credit application system, the method comprising the steps of:
obtaining at least one fictional credit applicant entity having a credit history associated therewith from an entity database comprising a one or more of fictional credit applicant entities;
accessing a networked credit offer portal;
providing information associated with the at least one fictional credit applicant entity and the credit history associated therewith;
executing at least part of a credit application process;
recording transaction steps of the at least part of the credit application process;
deleting at least some data created during the step of executing the at least part of the credit application process.

12. The method of claim 11, wherein the step of deleting occurs only after a predetermined period of time has elapsed.

13. The method of claim 11, wherein the step of executing the at least part of the credit application process comprises the step of validating an identity of the at least one fictional credit applicant entity.

14. The method of claim 13, wherein the step of validating the identity of the at least one fictional credit applicant entity comprises the step of matching a social security number to a last name.

15. The method of claim 11, wherein the step of executing the at least part of the credit application process comprises the step of analyzing the credit history associated with the at least one fictional credit applicant entity.

16. The method of claim 15, wherein the step of analyzing the credit history associated with the at least one fictional credit applicant entity comprises the step of accessing financial records.

17. The method of claim 11, wherein the step of executing the at least part of the credit application process comprises the step of communicating a credit response to the at least one fictional credit applicant entity.

18. The method of claim 17, wherein the step of communicating the credit response further comprises the step of sending an advertisement for an additional financial product.

19. The method of claim 11, further comprising the step of monitoring and recording customer access data in the networked credit offer portal.

20. The method of claim 11, further comprising the step of verifying the networked credit offer portal is operational.

21. The method of claim 20, wherein the networked credit offer portal is configured to present a plurality of client interface modules, wherein the step of verifying the networked credit offer portal is operational comprises verifying the networked credit offer portal is capable of presenting each of the plurality of client interface modules.

22. The method of claim 21, wherein when the networked credit offer portal malfunctions, the networked credit offer portal is configured to identify which of the plurality of client interface modules cannot be presented.

23. The method of claim 11, wherein the step of recording comprises the step of storing images of client interface modules presented by the networked credit offer portal in a system of records.

24. The method of claim 11, wherein the step of recording further comprises the step of generating a process flow diagram.
